(19) United States
(12) Patent Application Publication
(10) Pub. No.: US 2021/0031417 A1
(43) Pub. Date: Feb. 4, 2021

(54) INJECTION MOLDING MACHINE

(71) Applicant: FANUC CORPORATION, Minamitsuru-gun (JP)

(72) Inventors: Satoshi YANO, Minamitsuru-gun (JP); Ikuhiro MAKI, Minamitsuru-gun, (JP)

(21) Appl. No.: 16/942,099

(22) Filed: Jul. 29, 2020

(30) Foreign Application Priority Data
Jul. 31, 2019 (JP) 2019-140463

(51) Int. Cl. B29C 45/17; B29C 45/07; B29C 45/20

(52) U.S. Cl. CPC B29C 45/1773; B29C 45/07; B29C 2045/1785; B29C 45/1761; B29C 45/20

(57) ABSTRACT

In an injection molding machine, which includes an injection unit, a base that supports the injection unit, and a swivel shaft provided on the injection unit, the injection molding machine includes a driven rotating member provided on the swivel shaft and which rotates integrally with the swivel shaft, and an input unit for inputting a rotational force to the driven rotating member.

### CROSS-REFERENCE TO RELATED APPLICATION

This application is based upon and claims the benefit of priority from Japanese Patent Application No. 2019-140463 filed on Jul. 31, 2019, the contents of which are incorporated herein by reference.

### BACKGROUND OF THE INVENTION

### Field of the Invention

The present invention relates to an injection molding machine.

### Description of the Related Art

As disclosed in Japanese Laid-Open Patent Publication No. 09-039032, an injection molding machine is known that includes an injection unit in which a pivot pin is provided. The disclosed injection unit can be pivoted or swiveled about the pivot pin.

### SUMMARY OF THE INVENTION

When the injection unit is made to swivel, of course, a force for carrying out such swiveling must be applied to the injection unit. If the injection unit is light in weight, the injection unit can be made to swivel easily by being manually pushed by an operator. However, as the injection unit becomes heavier in weight, a larger force is required to cause the injection unit to swivel, and therefore, it becomes difficult for the injection unit to be swiveled by hand.

Thus, the present invention has the object of providing an injection molding machine in which swiveling of the injection unit is facilitated.

One aspect of the present invention is characterized by an injection molding machine including an injection unit, a base configured to support the injection unit, and a swivel shaft provided on the injection unit, the injection molding machine including a driven rotating member provided on the swivel shaft, and configured to rotate integrally with the swivel shaft, and an input unit configured to input a rotational force to the driven rotating member.

According to the present invention, the injection molding machine is provided in which swiveling of the injection unit is facilitated.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a side view of an injection molding machine according to an embodiment of the present invention;

FIG. 2 is a top view of an injection unit according to the embodiment;

FIG. 3 is a top view of a driven rotating member and an input unit according to the embodiment;

FIG. 4 is a top view of the injection unit according to a first modification;

FIG. 5 is a top view of the injection unit according to a second modification; and

FIG. 6 is a top view of the injection unit according to a third modification.

### DESCRIPTION OF THE PREFERRED EMBODIMENTS

A preferred embodiment of an injection molding machine according to the present invention will be presented and described in detail below with reference to the accompanying drawings.

### Embodiments

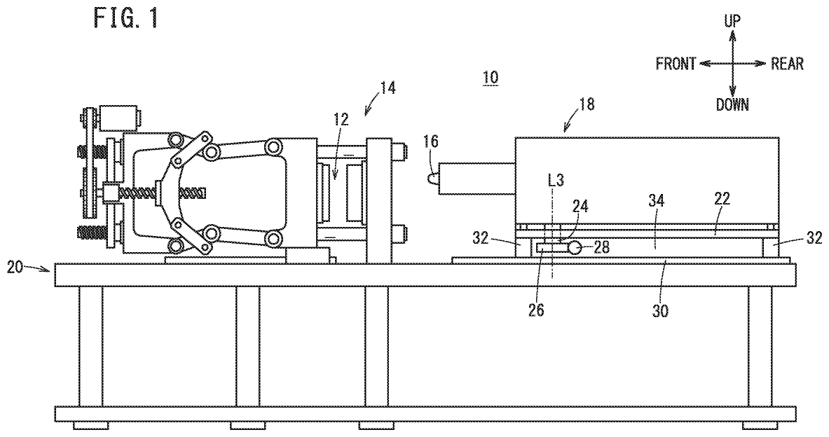

FIG. 1 is a side view of an injection molding machine 10 according to an embodiment of the present invention.

The injection molding machine 10 includes a mold clamping unit 14 having a mold 12, an injection unit 18 having a nozzle 16, and a machine base 20 on which the mold clamping unit 14 and the injection unit 18 are supported. The injection molding machine 10 connects the nozzle 16 and the mold 12 (in a nozzle touching state) and closes the mold 12 for clamping, and in this state serves to inject a molding material, which has been melted or softened by the injection unit 18, from the nozzle 16 into the mold 12. Thereafter, the mold 12 is opened and the molded product is taken out. The molding material is primarily a resin (plastic), however, a metal powder may also be used.

The injection molding machine 10 further includes a base 22 that supports the injection unit 18, a swivel shaft 24 provided on the injection unit 18, a driven rotating member 26 provided on the swivel shaft 24 and which rotates integrally with the swivel shaft 24, and an input unit 28 for inputting a rotational force to the driven rotating member 26.

The base 22 according to the present embodiment is a slide base that is supported by a guide rail 30 and a plurality of linear guides 32, so as to be capable of moving back and forth with respect to the mold clamping unit 14. Consequently, by advancing and retracting the injection unit 18, the injection molding machine 10 can easily accomplish connection and disconnection between the nozzle 16 and the mold 12.

The base 22 is supported (positioned in a vertical direction) at a predetermined height on the machine base 20 by the guide rail 30 and the plurality of linear guides 32. Consequently, a space (gap) 34 in the vertical direction is formed between the base 22 and the machine base 20.

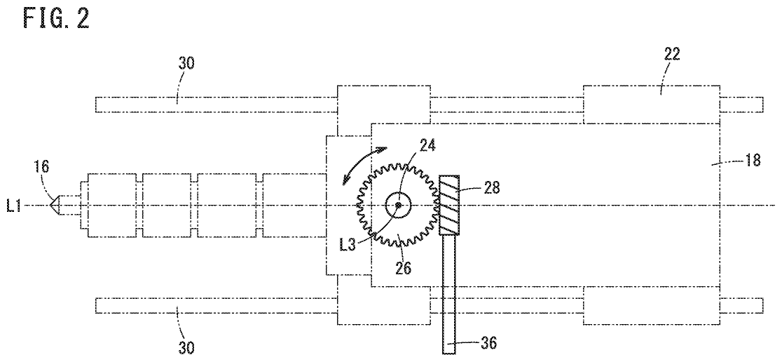

FIG. 2 is a top view of the injection unit 18 according to the present embodiment.

The swivel shaft 24 is a member that serves as an axis when the injection unit 18 is made to swivel. As shown in FIG. 1, the swivel shaft 24 is disposed on the side of the base 22 (in a downward direction) of the injection unit 18, and on an axis L1 of the nozzle 16 as shown in FIG. 2. The swivel shaft 24 penetrates through the base 22 and extends into the space 34. Moreover, the swivel shaft 24 does not contact the machine base 20.

When the nozzle 16 and the mold 12 are connected (placed in a nozzle touching state), a reaction force of such nozzle touching is received by the swivel shaft 24. However, by disposing the swivel shaft 24 on the axis L1 of the nozzle 16, since a rotational moment is not generated about the swivel shaft 24, any concern that the direction of the nozzle 16 will be shifted or deviated from the direction of the mold 12 can be reduced.

Although not limited to this feature, the driven rotating member 26 can be provided on a side of the swivel shaft 24 within the space 34, as shown in FIG. 1. The driven rotating member 26 does not contact the machine base 20. In accordance with this feature, the load of the injection unit 18 is supported by the base 22, and such a load is not applied to the driven rotating member 26.

The driven rotating member 26 is a gear member having a plurality of teeth. The gear member of the present embodiment can be appropriately selected from among general gear members including spur gears, helical gears, and bevel gears. According to the present embodiment, as an example, the driven rotating member 26 is a “helical gear”.

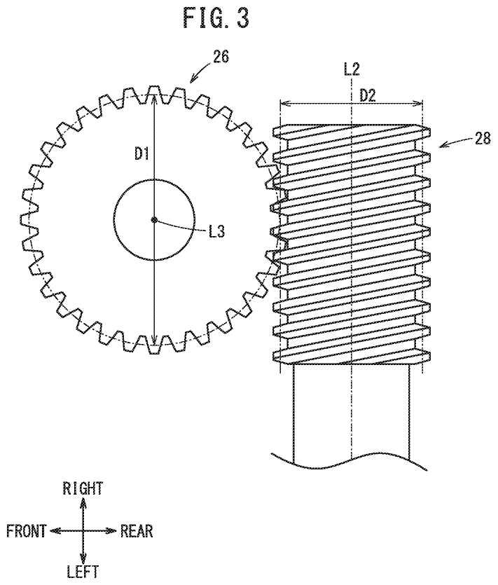

The input unit 28 is another gear member that is enmeshed and undergoes rotation with the driven rotating member 26. Although not limited to this feature, the input unit 28 of the present embodiment is assumed to be a substantially cylindrical “worm gear” that extends in the left and right directions. In this case, the rotary axis (axis of rotation) L2 of the input unit 28, which is a worm gear, and the rotary axis L3 of the driven rotating member 26, which is a helical gear, are perpendicular to each other (see FIG. 3).

Further, an operation unit 36 is provided on the input unit 28. The operation unit 36, for example, is a gripping member that extends in the left and right directions so as to be capable of being easily gripped by the operator.

The operator, by causing the input unit 28 to rotate, causes the driven rotating member 26 to be driven due to such rotation, and is capable of easily causing the swivel shaft 24, which is provided integrally with the driven rotating member 26, and the injection unit 18 on which the swivel shaft 24 is provided to be easily swiveled.

FIG. 3 is a top view of the driven rotating member 26 and the input unit 28 according to the present embodiment.

The diameters of the enmeshing portions of the gears of the driven rotating member 26 and the input unit 28 are referred to as “reference circle diameters (reference pitch circle diameters)”. More specifically, the driven rotating member 26 has a reference circle centered about the rotary axis L3. Hereinafter, the reference circle diameter of the driven rotating member 26 will be referred to as “D1”.

The input unit 28 has a reference circle centered about the rotary axis L2. Hereinafter, the reference circle diameter of the input unit 28 will be referred to as “D2”. The reference circle diameter D2 of the input unit 28 is preferably smaller than the reference circle diameter D1 of the driven rotating member 26 (D1>D2). Consequently, the driven rotating member 26 and the input unit 28 function as a so-called “speed reduction mechanism”. Accordingly, when the input unit 28 undergoes one rotation, a rotational force that is greater than the force required to bring about the one rotation is input to the driven rotating member 26.

The present embodiment is not limited to the description given above. For example, in the above description, a description was given in which the swivel shaft 24 is disposed on the axis L1 of the nozzle 16. Even if the swivel shaft 24 is not disposed on the axis L1 of the nozzle 16, the injection unit 18 can still be made to swivel about the swivel shaft 24. Accordingly, the swivel shaft 24 need not necessarily be disposed on the axis L1 of the nozzle 16.

Further, in order to reduce any concern that the injection unit 18 may unintentionally undergo swiveling when the nozzle 16 and the mold 12 are connected, a stopper that restricts swiveling of the injection unit 18 may be suitably provided. In particular, such a stopper is preferably provided in the case that the swivel shaft 24 is not disposed on the axis L1 of the nozzle 16. Such a stopper is preferably detachable, so that it can be removed when it is desired to allow the injection unit 18 to swivel.

### MODIFICATIONS

Although an embodiment has been described above as one example of the present invention, it goes without saying that various modifications or improvements are capable of being added to the above-described embodiment. It is clear from the scope of the claims that other modes to which such modifications or improvements have been added can be included within the technical scope of the present invention.

### Modification 1

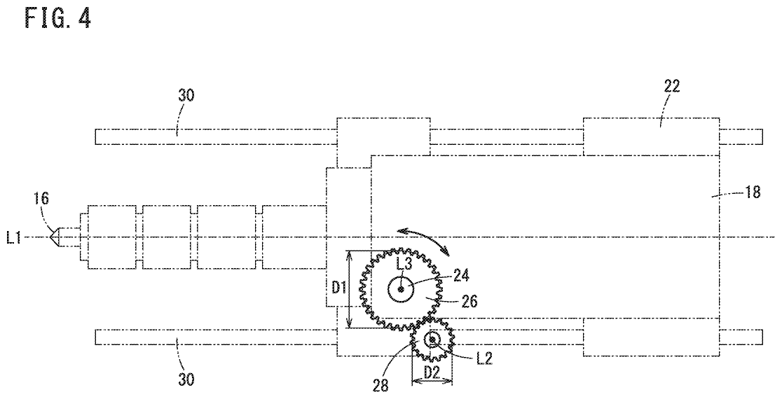

FIG. 4 is a top view of the injection unit 18 according to a first modification (Modification 1).

In the embodiment, a description was given in which the driven rotating member 26 is a gear member that is provided so as to be capable of rotating, and the input unit 28 is a gear member that is enmeshed and undergoes rotation with the driven rotating member 26. In this case, the rotary axis L2 of the input unit 28 and the rotary axis L3 of the driven rotating member 26 may be parallel with each other. Each of the input unit 28 and the driven rotating member 26 of the present modification, for example, is a spur gear or a helical gear.

In comparison with a worm gear that rotates perpendicularly with respect to the rotary axis L3 of the driven rotating member 26, a gear member that rotates in parallel with the rotary axis L3 of the driven rotating member 26 can more easily suppress the dimension in the vertical direction. Accordingly, any adverse influence on the position of the injection unit 18 in the vertical direction due to providing the input unit 28 and the driven rotating member 26 can be suppressed to a minimum.

The reference circle diameter D2 of the input unit 28 is preferably smaller than the reference circle diameter D1 of the driven rotating member 26 (D1>D2). In accordance with this feature, when the input unit 28 undergoes one rotation, a rotational force that is greater than the force required to bring about the one rotation is input to the driven rotating member 26. Further, in the same manner as in the above-described embodiment, the operation unit 36 may be provided on the input unit 28. In accordance with this feature, the operator can more easily input the force to the driven rotating member 26.

According to the present modification, in a similar manner to the embodiment, the operator is capable of easily causing the injection unit 18 to swivel.

### Modification 2

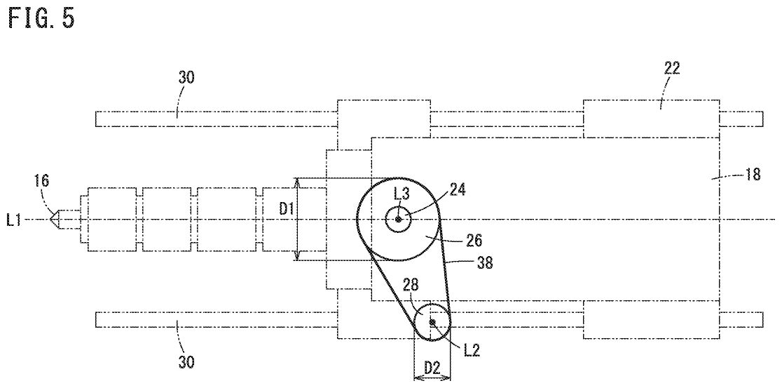

FIG. 5 is a top view of the injection unit 18 according to a second modification (Modification 2).

Each of the input unit 28 and the driven rotating member 26, which include the axes of rotation L2 and L3 that are parallel with each other, may be substantially circular shaped rotating members that are separated from each other. In this case, the injection molding machine 10 may further be equipped with a belt member 38 which transmits the rotation of the input unit 28 to the driven rotating member 26. Consequently, in the same manner as in the above-described embodiment, the operator is capable of easily causing the injection unit 18 to swivel.

The substantially circular shaped rotating members may be gear members having teeth, or alternatively pulleys that do not have teeth. The belt member 38 is appropriately selected from among several types such as a toothed belt or a flat belt, in accordance with the shapes of the input unit 28 and the driven rotating member 26.

The reference circle diameter D2 of the input unit 28, in the same manner as in Modification 1, is preferably smaller than the reference circle diameter D1 of the driven rotating member 26 (D1>D2). In accordance with this feature, when the input unit 28 undergoes one rotation, a rotational force that is greater than the force required to bring about the one rotation is input to the driven rotating member 26.

The injection molding machine 10 of the present modification may further be equipped with at least one rotating member that transmits the rotation of the input unit 28 to the driven rotating member 26. Such a rotating member, for example, is a pulley that is in contact with the input unit 28 and the driven rotating member 26. Such a pulley, for example, has a rotary axis that is parallel with the axes of rotation L2 and L3, and is rotated by being driven by the input unit 28. In this case, belt members are provided respectively between the driven rotating member 26 and the rotating member, and between the rotating member and the input unit 28, and the belt members transmit rotation. Consequently, in the same manner as in the above-described embodiment, the operator is capable of easily causing the injection unit 18 to swivel.

### Modification 3

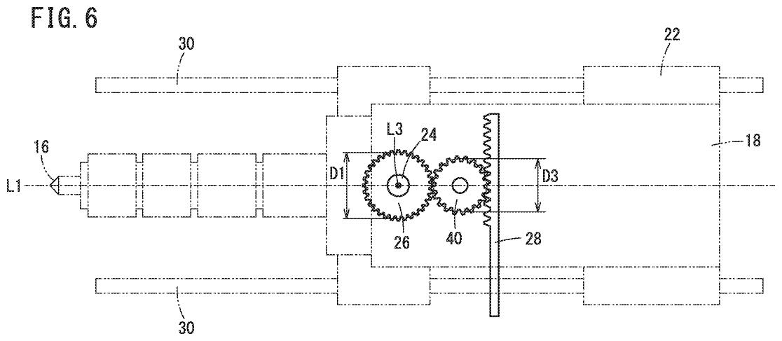

FIG. 6 is a top view of the injection unit 18 according to a third modification (Modification 3).

The driven rotating member 26 may be a pinion of a rack and pinion, and the input unit 28 may be a rack of the rack and pinion. In accordance with this feature, the operator can easily cause the injection unit 18 to swivel by subjecting the input unit 28 to sliding movement in the left and right directions shown in the drawing.

Further, according to the present modification, as shown in FIG. 6, it is preferable to provide another gear member 40 that is enmeshed with the driven rotating member (the pinion) 26 and the input unit (the rack) 28. A reference circle diameter D3 of the gear member 40 is preferably smaller than the reference circle diameter D1 of the driven rotating member 26 (D1>D3). In accordance with this feature, when the input unit 28 is subjected to sliding movement, a rotational force which is greater than the force required by the operator to bring about such sliding movement is input to the driven rotating member 26.

### Modification 4

In the embodiment, a description was given in which the operation unit 36 may be provided that enables the operator to more easily input the force to the driven rotating member 26. The injection molding machine 10 may further be equipped with a motor which, by being rotated, inputs the force to the input unit 28 and the driven rotating member 26. In accordance with this feature, the injection unit 18 can be made to swivel easily without the operator having to input the force to the input unit 28.

### Modification 5

In Modification 4, a description was given in which the force may be input by the motor to the driven rotating member 26. The injection molding machine 10 is not limited to using a motor, and may include a pressurizing device that applies a pneumatic pressure, an oil-based hydraulic pressure, or a water-based hydraulic pressure to the input unit 28 and the driven rotating member 26. In accordance with this feature, the injection unit 18 can be made to swivel easily without the operator having to input the force to the input unit 28.

### Modification 6

The above-described embodiments and the modifications thereof may be appropriately combined within a range in which no technical inconsistencies occur.

### Inventions that can be Obtained from the Embodiment

The inventions that can be grasped from the above-described embodiment and the modifications thereof will be described below.

In the injection molding machine (10), which includes the injection unit (18), the base (22) configured to support the injection unit (18), and the swivel shaft (24) provided on the injection unit (18), the injection molding machine includes the driven rotating member (26) provided on the swivel shaft (24), and configured to rotate integrally with the swivel shaft (24), and the input unit (28) configured to input the rotational force to the driven rotating member (26).

In accordance with such features, the injection molding machine (10) is provided in which rotation of the injection unit (18) is facilitated.

The driven rotating member (26) may be a gear member that is provided so as to be rotatable, and the input unit (28) may include teeth enmeshed with the driven rotating member (26). In accordance with this feature, the force can be input to the driven rotating member (26) by the input unit (28) that is enmeshed with the driven rotating member (26), and the injection molding machine (10) in which rotation of the injection unit (18) is facilitated can be provided.

The input unit (28) may be a gear member configured to rotate by enmeshment with the driven rotating member (26), and the rotary axis (L2) of the input unit (28) and the rotary axis (L3) of the driven rotating member (26) may be perpendicular to each other. In accordance with this feature, by the input unit (28) that is enmeshed with the driven rotating member (26), it becomes easier to input the force to the driven rotating member (26).

The input unit (28) may be a gear member configured to rotate by enmeshment with the driven rotating member (26), and the rotary axis (L2) of the input unit (28) and the rotary axis (L3) of the driven rotating member (26) may be parallel with each other. In accordance with this feature, by the input unit (28) that is enmeshed with the driven rotating member (26), it is possible to input the force to the driven rotating member (26). Further, any adverse influence on the position of the injection unit (18) in the vertical direction due to providing the input unit (28) and the driven rotating member (26) can be suppressed to a minimum.

The input unit (28) and the driven rotating member (26), respectively, may be substantially circular shaped rotating members that are separated from each other, and the injection molding machine (10) further includes the belt member (38) configured to transmit the rotation of the input unit (28) to the driven rotating member (26). In accordance with such features, the force can be input to the driven rotating member (26) by the input unit (28) and the belt member (38).

The reference circle diameter (D2) of the input unit (28) may be smaller than the reference circle diameter (D1) of the driven rotating member (26). In accordance with this feature, when the input unit (28) undergoes one rotation, a rotational force that is greater than the force required to bring about the one rotation is input to the driven rotating member (26).

The driven rotating member (26) may be a pinion of a rack and pinion, and the input unit (28) may be a rack of the rack and pinion. In accordance with this feature, the force can be input to the driven rotating member (26) by the input unit (the rack) (28) that is enmeshed with the driven rotating member (the pinion) (26), and the injection molding machine (10) in which rotation of the injection unit (18) is facilitated can be provided.

The input unit (28) may include the operation unit (36) through which the operator inputs the force to the driven rotating member (26). In accordance with this feature, the operator can more easily input the force to the driven rotating member (26).

There may further be provided the motor configured to input the force to the driven rotating member (26) by being rotated. In accordance with this feature, the injection unit (18) can be made to swivel easily without the operator having to input the force to the input unit (28).

The swivel shaft (24) may be disposed on the axis (L1) of the nozzle (16) of the injection unit (18). In accordance with this feature, any concern that the injection unit (18) may unintentionally undergo swiveling when the nozzle (16) and the mold (12) are connected can be reduced.

The space (34) may be provided on a side opposite from the injection unit (18) sandwiching the base 22 therebetween, the swivel shaft (24) may extend to the space (34), and the driven rotating member (26) may be provided on the side of the swivel shaft (24) within the space (34). In accordance with this feature, the load of the injection unit (18) is supported by the base (22), and such a load is not applied to the driven rotating member (26).

What is claimed is:

1. An injection molding machine including an injection unit, a base configured to support the injection unit, and a swivel shaft provided on the injection unit, the injection molding machine comprising:
a driven rotating member provided on the swivel shaft, and configured to rotate integrally with the swivel shaft; and
an input unit configured to input a rotational force to the driven rotating member.

2. The injection molding machine according to claim 1, wherein the driven rotating member is a gear member that is provided so as to be rotatable, and the input unit includes teeth enmeshed with the driven rotating member.

3. The injection molding machine according to claim 2, wherein:
the input unit is a gear member configured to rotate by enmeshment with the driven rotating member; and
a rotary axis of the input unit and a rotary axis of the driven rotating member are perpendicular to each other.

4. The injection molding machine according to claim 2, wherein:
the input unit is a gear member configured to rotate by enmeshment with the driven rotating member; and
a rotary axis of the input unit and a rotary axis of the driven rotating member are parallel with each other.

5. The injection molding machine according to claim 1, wherein:
the input unit and the driven rotating member, respectively, are substantially circular shaped rotating members that are separated from each other; and
the injection molding machine further comprises a belt member configured to transmit rotation of the input unit to the driven rotating member.

6. The injection molding machine according to claim 3, wherein a reference circle diameter of the input unit is smaller than a reference circle diameter of the driven rotating member.

7. The injection molding machine according to claim 4, wherein a reference circle diameter of the input unit is smaller than a reference circle diameter of the driven rotating member.

8. The injection molding machine according to claim 5, wherein a reference circle diameter of the input unit is smaller than a reference circle diameter of the driven rotating member.

9. The injection molding machine according to claim 2, wherein the driven rotating member is a pinion of a rack and pinion, and the input unit is a rack of the rack and pinion.

10. The injection molding machine according to claim 1, wherein the input unit comprises an operation unit through which an operator inputs the force to the driven rotating member.

11. The injection molding machine according to claim 1, further comprising a motor configured to input the force to the driven rotating member by being rotated.

12. The injection molding machine according to claim 1, wherein the swivel shaft is disposed on an axis of a nozzle of the injection unit.

13. The injection molding machine according to claim 1, wherein:
a space is provided on a side opposite from the injection unit sandwiching the base therebetween;
the swivel shaft extends to the space; and
the driven rotating member is provided on a side of the swivel shaft within the space.
